(19) United States
(12) Patent Application Publication
(10) Pub. No.: US 2026/0011468 A1
(43) Pub. Date: Jan. 8, 2026

(54) TWISTED CONNECTING WIRES

(71) Applicant: Chroma ATE INC, Taoyuan (TW)

(72) Inventors: Chien-Hsing HUANG, Taoyuan (TW); Hao-Jhan CHEN, Taoyuan (TW)

(21) Appl. No.: 18/967,053

(22) Filed: Dec. 3, 2024

(30) Foreign Application Priority Data
Jul. 4, 2024 (TW) 113125155

(51) Int. Cl. H01B 7/00; H01R 11/12

(52) U.S. Cl. CPC H01B 7/0009; H01R 11/12

(57) ABSTRACT

The present invention provides twisted connecting wires for connecting a power supply device and an electronic device and transmitting current. The twisted connecting wires include a first wire group and a second wire group. The first wire group includes a plurality of first thin wires, and each of the first thin wires has a first twisted section. The second wire group includes a plurality of second thin wires, and each of the second thin wires has a second twisted section. The number of the second thin wires is the same as the number of the first thin wires, the current directions of the first thin wires and the second thin wires are opposite, and the first twisted sections and the second twisted sections are twisted one-to-one. The spaces between the first thin wires and the second thin wires after they are twisted becomes smaller, thereby reducing the total inductance.

### CROSS-REFERENCE TO RELATED APPLICATIONS

This non-provisional application claims priority under 35 U.S.C. § 119(a) on Patent Application No(s). 113125155 filed in Taiwan, on Jul. 4, 2024, the entire contents of which are hereby incorporated by reference.

### TECHNICAL FIELD

The present invention relates to a twisted connecting wire, which is a wire through which the current flows. It can be used to connect an electronic device or a power supply device. In particular, it refers to a connecting wire for significantly reducing the total inductance.

### DESCRIPTION OF THE RELATED ART

In order to ensure the quality of electronic components, manufacturers complete a variety of inspections and tests before delivering the electronic components from the factory. For example, the electronic devices are connected to power supply devices (e.g., power supply apparatuses) to simulate the power consumption of the power supply devices for testing purposes. During the test, two twisted connecting wires are used to electrically connect the power supply device to the electronic device, so that the two twisted connecting wires can be used as a current transmitting and receiving path. It is well-known that the diameter of the connecting wire depends on the magnitude of the transmitted current. If only two connecting wires are used as the current transmitting and receiving path, the connecting wire with larger wire diameter is usually used for safely transmitting the current. Due to the larger wire diameter of the used connecting wire, the space between the two connecting wires twisted together will increase. Accordingly, the inductance on the current transmitting and receiving path will increase when the current flows back and forth between the two connecting wires, which results in the loss of the connecting wires.

Therefore, how to reduce the inductance on the current transmitting and receiving path of the two connecting wires after being twisted together is an urgent design issue.

### BRIEF SUMMARY OF THE INVENTION

In order to solve the above conventional problems, the present invention divides the wire diameter of the first wire groups and the second wire group into a plurality of first thin wires and second thin wires under the condition of transmitting the predetermined current, and each first thin wire and each second thin wire are twisted to form a set of current transmitting and receiving paths. As such, the twisted connecting wire includes multiple sets of current transmitting and receiving paths. Due to the thinning of the first thin wires and the second thin wires, the contacting area of the first thin wire and the second thin wire increases, the spacing decreases. Accordingly, the inductance generated on the current transmitting and receiving path decreases, and the loss rate of the first wire group and the second wire group decreases.

The present invention provides a twisted connecting wire used for connecting between a power supply device and an electronic device and transmitting current. It includes a first wire group and a second wire group. The first wire group includes a plurality of first thin wires, and each of the first thin wires has a first twisted section. The second wire group includes a plurality of second thin wires, and each of the second thin wires has a second twisted section. The number of the second thin wires is the same as the number of the first thin wires. The first twisted sections and the second twisted sections are twisted one-to-one. When the twisted connecting wire is used as a current transmitting and receiving path between the power supply device and the electronic device, the current direction of the first thin wires is opposite to the current direction of the second thin wires.

In a preferred embodiment, the space between the first twisted sections and the second twisted sections of each group is equal to a sum of a radius of the first thin wires and a radius of the second thin wires.

In a preferred embodiment, each of the first thin wires comprises a first front section, the first twisted section and a first rear section, and the first twisted section is located between the first front section and the first rear section.

In a preferred embodiment, the first front sections are gathered and joined to form a first front end portion, and the first rear sections are gathered and joined to form a first rear end portion.

In a preferred embodiment, it further includes a first front terminal and a first rear terminal, the first front terminal is fixedly connected to the first front end portion, and the first rear terminal is fixedly connected to the first rear end portion.

In a preferred embodiment, each of the second thin wires comprises a second front section, the second twisted section and a second rear section. The second twisted section is located between the second front section and the second rear section.

In a preferred embodiment, the second front sections are gathered and joined to form a second front end portion, and the second rear sections are gathered and joined to form a second rear end portion.

In a preferred embodiment, it further includes a second front terminal and a second rear terminal, the second front terminal is fixedly connected to the second front end portion, and the second rear terminal is fixedly connected to the second rear end portion.

In a preferred embodiment, it further includes a bundle sleeve. The bundle sleeve is set on an outer surface of the first twisted sections and the second twisted sections twisted together.

### BRIEF DESCRIPTION OF THE DRAWINGS

FIG. 1 is a three-dimensional schematic view of the twisted connecting wire of the present invention.

FIG. 2 is a three-dimensional schematic view of one of the groups of the first thin wires and the second thin wires of the twisted connecting wire of the present invention after being twisted together.

FIG. 3 is a three-dimensional schematic view of several groups of the first thin wires and the second thin wires of the twisted connecting wire of the present invention after being twisted together.

FIG. 4 is a three-dimensional schematic view of the twisted connecting wire provided with terminals according to the present invention.

FIG. 5 is a three-dimensional schematic view of the twisted connecting wire connected to the power supply device and the electronic device of the present invention.

FIG. 6 is a cross-sectional view of the first wire group of the twisted connecting wire of the present invention.

FIG. 7 is a cross-sectional view of the second wire group of the twisted connecting wire of the present invention.

FIG. 8 is a cross-sectional view of one of the groups of the first thin wires and the second thin wires of the twisted connecting wire of the present invention after being twisted together.

FIG. 9 is a three-dimensional schematic view of the twisted connecting wire of the present invention provided with a bundle sleeve.

### DETAILED DESCRIPTION OF THE INVENTION

The technical solutions in the embodiments of the present invention are described clearly and completely below in association with the accompanying drawings in the embodiments of the present invention. Many specific details are set forth in the following description in order to facilitate a full understanding of the present invention, but the present invention can also be implemented in other ways different from those described herein. Persons skilled in the art can make similar promotions without violating the connotations of the present invention, and thus the present invention is not limited by the specific embodiments disclosed hereinafter.

Other technical contents, features and effects of the present invention will be clearly presented in the following detailed description of the preferred embodiments with reference to the drawings.

As used herein, the articles “a”, “an” and “any” refer to the grammar of one or more than one (i.e. at least one) item, unless a specific number is specified. For example, “an element” means one element or more than one element.

As used herein, the terms “first”, “second”, etc. are only used to distinguish the described elements and are not to be construed as indicating or implying relative importance, order of use, or order of arrangement.

As used herein, the term “section” refers to a cross section perpendicular to the axis of the twisted connecting wire. The term “cross-sectional area” refers to the area cut by a cross section perpendicular to the axis of the twisted connecting wire.

As used herein, the term “space” refers to the distance from the center of a wire to the center of another wire, such as the distance from the center of a first thin wire to the center of a second thin wire.

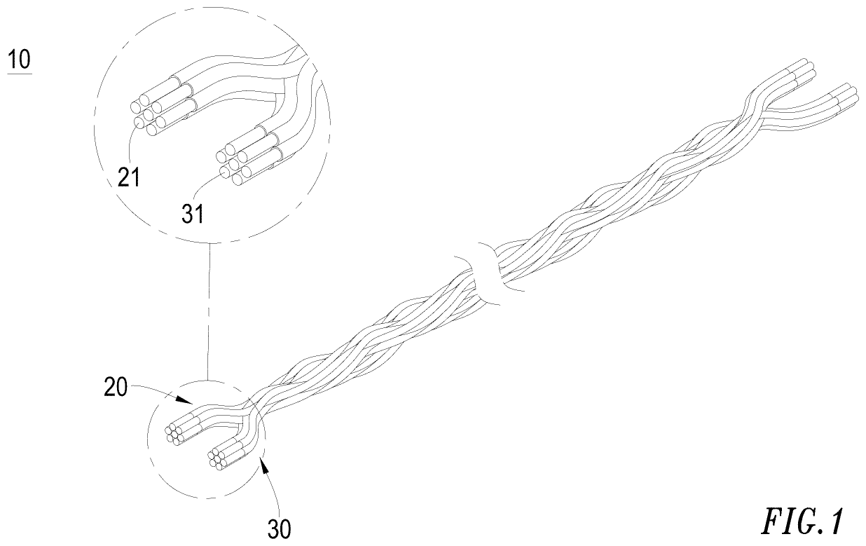

Please refer to FIG. 1. FIG. 1 is a three-dimensional schematic view of the twisted connecting wire 10 of the present invention. The twisted connecting wire 10 of the present invention includes a first wire group 20 and a second wire group 30. The first wire group 20 includes a plurality of first thin wires 21, and the second wire group 30 includes a plurality of second thin wires 31. The number of the first thin wires 21 is the same as the number of the second thin wires 31. In the embodiment, the number of the first thin wires 21 and the number of the second thin wires 31 are both seven. In other embodiments, as long as the number of the first thin wires 21 and the second thin wires is greater than two, they fall within the scope of the first wire group 20 and the second wire group 30 in the embodiment of the invention.

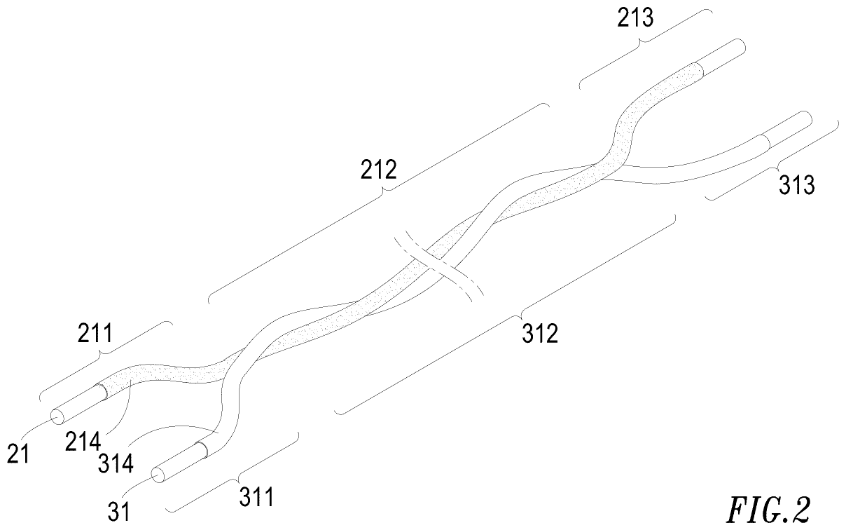

Please refer to FIG. 2. FIG. 2 is a three-dimensional schematic view of one of the groups of the first thin wires 21 and the second thin wires 31 of the twisted connecting wire 10 of the present invention after being twisted together. The first thin wire 21 has a first front section 211, a first twisted section 212 and a first rear section 213. The first twisted section 212 is located between the first front section 211 and the first rear section 213. The second thin wire 31 has a second front section 311, a second twisted section 312 and a second rear section 313. The second twisted section 312 is located between the second front section 311 and the second rear section 313. The first twisted section 212 of each first thin wire 21 and the second twisted section 312 of each second thin wire 31 are twisted one-to-one. Each group of the twisted first thin wires 21 and the twisted second thin wires 31 can be used as a current transmitting and receiving path. Therefore, a plurality of groups of each first thin wire 21 and each second thin wire 31 twisted together can be used as a plurality of current transmitting and receiving paths.

In the embodiment, each first thin wire 21 has a first insulating cover 214, and each first insulating cover 214 has the same color. Each second thin wire 31 has a second insulating cover 314, and each second insulating cover 214 has the same color. However, the color of each of the first insulating cover 214 is different from the color of each of the second insulating cover 314. The covers of different colors are used to distinguish the first wire group 20 and the second wire group 30, so as to facilitate connecting the first wire group 20 and the second wire group 30 to the correct positions between the power supply device and the electronic device, which are regarded as the correct current transmitting and receiving path.

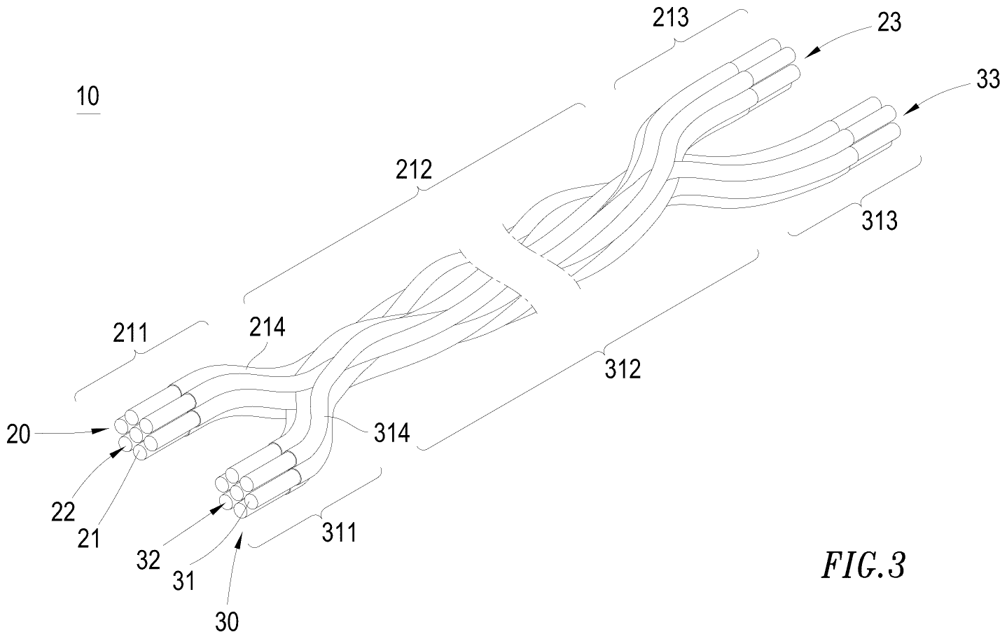

Please refer to FIG. 3. FIG. 3 is a three-dimensional schematic view of several groups of the first thin wires 21 and the second thin wires 31 of the twisted connecting wire 10 of the present invention after being twisted together. In the first wire group 20, each of the first front sections 211 is gathered and joined to form a first front end portion 22, and each of the first rear sections 213 is gathered and joined to form a first rear end portion 23. In the second wire group 30, each of the second front sections 311 is gathered and joined to form a second front end portion 32, and each of the second rear section 313 is gathered and joined to form a second rear end portion 33.

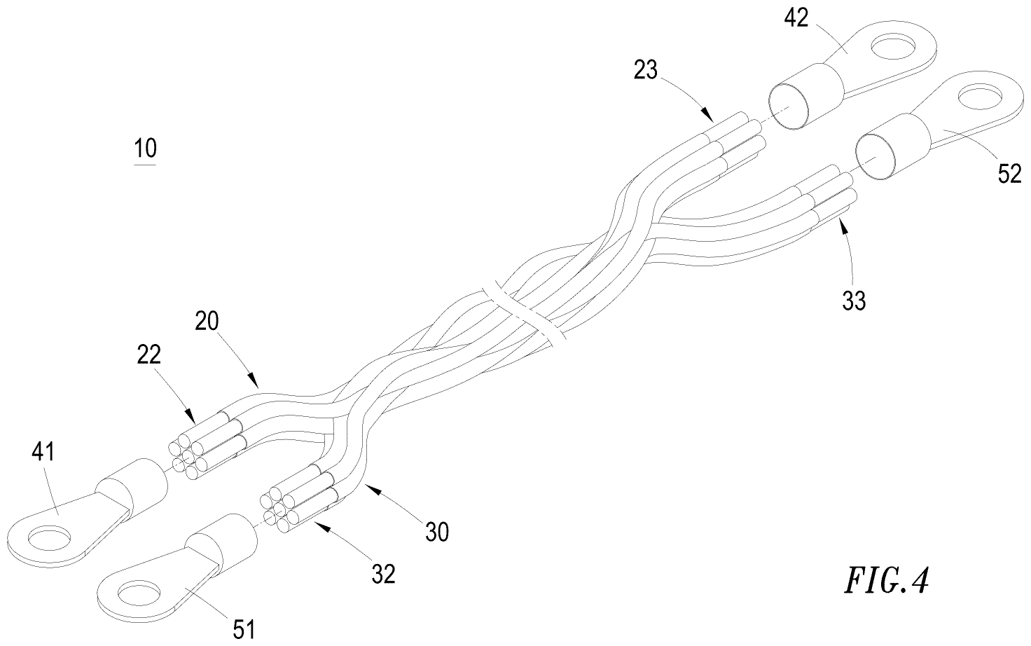

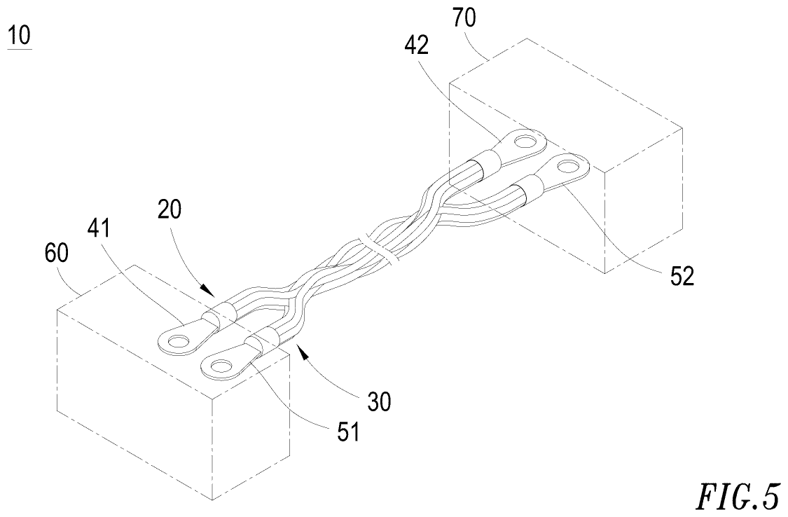

Please refer to FIG. 4. FIG. 4 is a three-dimensional schematic view of the twisted connecting wire 10 provided with terminals according to the present invention. The twisted connecting wire 10 further includes a first front terminal 41, a first rear terminal 42, a second front terminal 51 and a second rear terminal 52. The first front terminal 41 is fixedly connected to the first front end portion 22, and the first rear terminal 42 is fixedly connected to the first rear end portion 23. The second front terminal 51 is fixedly connected to the second front end portion 32, and the second rear terminal 52 is fixedly connected to the second rear end portion 33. The fixed connection may be welding, but is not limited thereto. Please also refer to FIG. 5. FIG. 5 is a three-dimensional schematic view of the twisted connecting wire 10 connected to the power supply device 60 and the electronic device 70 of the present invention. The first front terminal 41 and the second front terminal 51 are electrically connected to the positive electrode and the negative electrode of the power supply device 60 respectively, and the first rear terminal 42 and the second rear terminal 52 are electrically connected to the positive electrode and the negative electrode of the electronic device 70. In another embodiment, the first front terminal 41 and the second front terminal 51 are electrically connected to the negative electrode and the positive electrode of the power supply device 60 respectively, and the first rear terminal 42 and the second rear terminal 52 are electrically connected to the negative electrode and the positive electrode of the electronic device 70.

In order to demonstrate that the design of the twisted connecting wire 10 of the present invention is effective in reducing the inductance, the following inductance-related equations are illustrated for explanation.

I. Self-induction equation:

$$Ls = \frac{μ \cdot {N}^{2} \cdot A}{ι}$$

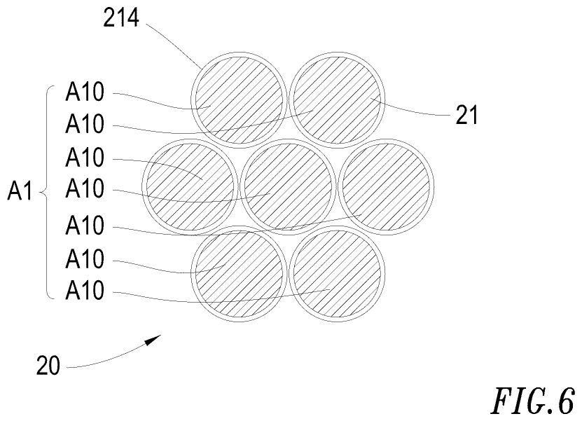

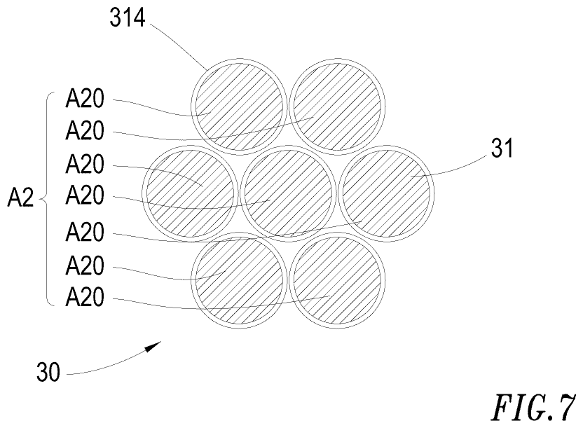

In the above equation, Ls represents the self-inductance, which is equivalent to the self-inductance of each first thin wire 21 or each second thin wire 31 in the embodiment. μ represents the magnetic permeability, N represents the number of turns of the wire, A represents the cross-sectional area of the wire, and ι represents the length of the wire. It can be inferred from the equation that when the conditions of the magnetic permeability μ, the number of turns of wire N and the length of wire ι remain unchanged, the cross-sectional area of the wire A is proportional to the self-inductance Ls. As such, please refer to FIG. 6 and FIG. 7. FIG. 6 is a cross-sectional view of the first wire group 20 of the twisted connecting wire 10 of the present invention, and FIG. 7 is a cross-sectional view of the second wire group 30 of the twisted connecting wire 10 of the present invention. Among them, with the same wire diameter size (equivalent to the cross-sectional area A1 of the first wire group 20) sufficient to transmit a predetermined current, when the number of first thin wires 21 of the first wire group 20 is larger, the wire diameter of each first thin wire 21 is smaller, and the cross-sectional area A10 of each first thin wire is smaller, resulting in a smaller self-inductance Ls of each first thin wire 21. Similarly, with the cross-sectional area A2 of the second wire group 30, when the number of second thin wires 31 of the second wire group 30 is larger, the wire diameter of each second thin wire 31 is smaller, and the cross-sectional area A20 of each second thin wire is smaller, resulting in a smaller self-inductance Ls of each second thin wire 31.

II. Mutual-inductance equation:

$$Lm = - k * \sqrt{L 1 * L 2}$$

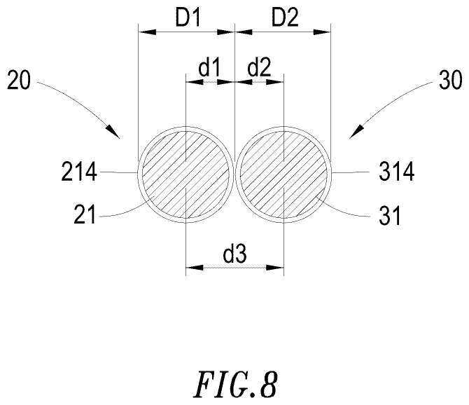

In the above equation, Lm is the mutual inductance, which is equivalent to the mutual inductance of the first thin wire 21 and the second thin wire 31 that are twisted together in the embodiment. k is a normalization coefficient that corresponds to the influence of the relative position and geometric shape between each first thin wire 21 and each second thin wire 31 on the mutual inductance Lm. L1 is the self inductance of each first thin wire 21, and L2 is the self inductance of each second thin wire 31. (1) Regarding the normalization coefficient k, please refer to FIG. 8. FIG. 8 is a cross-sectional view of the first thin wire 21 and the second thin wire 31 of the twisted connecting wire 10 of the present invention twisted together. The relative position between each first thin wire 21 and each second thin wire 31 is related to the space d3 between the first thin wire 21 and the second thin wire 31. The space d3 between the first thin wire 21 and the second thin wire 31 is equal to the sum of the radius d1 of the first thin wire 21 and the radius d2 of the second thin wire 31. Accordingly, the smaller the wire diameter D1 of each of the first thin wires 21 is, the smaller the wire diameter D2 of each of the second thin wires 31 is, and the space d3 between the first thin wire 21 and the second thin wire 31 after being twisted together is reduced. In addition, the normalization coefficient k is usually inversely proportional to the distance between each first thin wire 21 and each second thin wire 31, because when the space d3 decreases, the electric field and magnetic field interaction between them are stronger to increase the mutual inductance effect. Therefore, a smaller space d3 will result in a larger mutual inductance Lm, and a larger space d3 will result in a smaller mutual inductance Lm. (2) Regarding the mutual inductance Lm, in the embodiment, when each first thin wire 21 and each second thin wire 31 are used as a current transmitting and receiving path, it indicates that the current directions passing through each first thin wire 21 and each second thin wire 31 are opposite, resulting in the mutual inductance of each first thin wire 21 and each second thin wire 31 to be inverse induction. Therefore, in the embodiment, the mutual inductance Lm is a negative value.

As described in the above (1) and (2), the greater the number of each first thin wire 21 and each second thin wire 31, the smaller the wire diameters D1 and D2 of each first thin wire 21 and each second thin wire 31, the smaller the space d3 will be, and the smaller the space d3 will result in the greater the value of the mutual inductance Lm (absolute value). In addition, in the embodiment, the mutual inductance Lm is a negative value. As a result, it causes the value of mutual inductance Lm to change from a positive value to a negative value, and it can be inferred that a smaller space d3 results in a smaller value (negative value) of mutual inductance Lm.

III. Inductance equation:

$$L = ( Ls 1 + Ls 2 ) + Lm$$

In the above equation, L is the inductance of the twisted connecting wire 10, Ls1 is the self inductance of each first thin wire 21, Ls2 is the self inductance of each second thin wire 31, and Lm is mutual inductance between the first thin wire 21 and second thin wire 31 twisted together. As evidenced by the aforementioned self-inductance equation I and mutual-inductance equation II, the design of the twisted connecting wire 10 of the present invention reduces the self-inductances Ls1 and Ls2, and the mutual-inductance Lm, respectively. Accordingly, the inductance L of the twisted connecting wire 10 can also be reduced.

In addition, in the embodiment, each group of first thin wires 21 and second thin wires 31 twisted together are arranged in parallel, and the inductance parallel equation is:

$${L}_{total} = \frac{1}{\frac{1}{{L}_{1}} + \frac{1}{{L}_{2}} … \frac{1}{{L}_{n}}}$$

In the above equation, Lₜₒₜₐₗ is the total inductance of the twisted connecting wire 10 of the present invention, and L₁, L₂ . . . Lₙ are the inductances of each group of first thin wires 21 and second thin wires 31 twisted together. It can be inferred from the above equation that the more groups of twisted first thin wires 21 and twisted second thin wires 31 are connected in parallel, the smaller the total inductance of the twisted connecting wire 10 of the present invention will be.

Based on the foregoing, each first thin wire 21 and each second thin wire 31 are thinned by the present invention to reduce the self inductance and mutual inductance of each first thin wire 21 and each second thin wire 31, and also to reduce the inductance of the first thin wire 21 and the second thin wire 31 twisted together. Afterwards, multiple groups of the twisted first thin wires 21 and the twisted second thin wires 31 are connected in parallel, thereby reducing the total inductance of the twisted connecting wire 10 of the present invention.

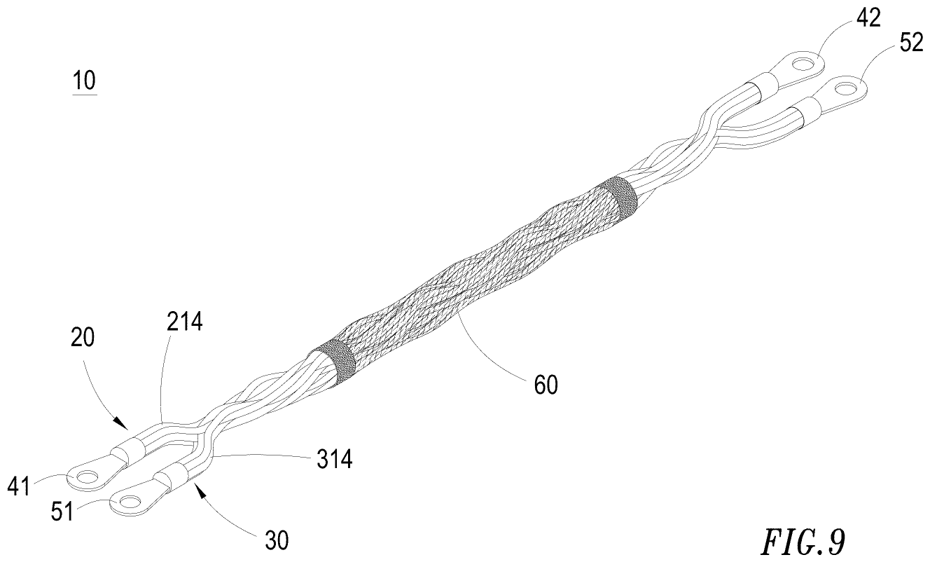

Please refer to FIG. 9. FIG. 9 is a three-dimensional schematic view of the twisted connecting wire 10 of the present invention provided with a bundle sleeve 80. As shown in the figure, the twisted connecting wire 10 further includes a bundle sleeve 80. The bundle sleeve 80 is set on the outer surface of the first twisted section 212 and the second twisted section 312, so that the first wire group 20 and the second wire group 30 are not easily separated. Furthermore, the bundle sleeve 80 protects the first insulating cover 214 and the second insulating cover 314. In the embodiment, the bundle sleeve 80 is a nylon braided mesh, but is not limited thereto.

The above examples are only a selection of some of the better embodiments of the invention, but they are not intended to limit the invention. Any person who is familiar with the general knowledge in this technical field and understands the aforesaid technical features and embodiments of the present invention, and makes equal variations or embellishments within the spirit and scope of the present invention, shall still fall within the scope of the utility model application. The scope of patent protection for the invention shall be as defined in the claim attached hereto.

What is claimed is:

1. A twisted connecting wire used for connecting between a power supply device and an electronic device and transmitting current, comprising:
a first wire group, comprising a plurality of first thin wires, each of the first thin wires having a first twisted section; and
a second wire group, comprising a plurality of second thin wires, each of the second thin wires having a second twisted section;
wherein a number of the second thin wires is the same as the number of the first thin wires, and the first twisted sections and the second twisted sections are twisted one-to-one, and when the twisted connecting wire is used as a current transmitting and receiving path between the power supply device and the electronic device, a current direction of the first thin wires is opposite to the current direction of the second thin wires.

2. The twisted connecting wire according to claim 1, wherein a space between the first twisted sections and the second twisted sections of each group is equal to a sum of a radius of the first thin wires and a radius of the second thin wires.

3. The twisted connecting wire according to claim 1, wherein each of the first thin wires comprises a first front section, the first twisted section and a first rear section, and the first twisted section is located between the first front section and the first rear section.

4. The twisted connecting wire according to claim 3, wherein the first front sections are gathered and joined to form a first front end portion, and the first rear sections are gathered and joined to form a first rear end portion.

5. The twisted connecting wire according to claim 4, further comprising: a first front terminal and a first rear terminal, the first front terminal is fixedly connected to the first front end portion, and the first rear terminal is fixedly connected to the first rear end portion.

6. The twisted connecting wire according to claim 1, wherein each of the second thin wires comprises a second front section, the second twisted section and a second rear section, and the second twisted section is located between the second front section and the second rear section.

7. The twisted connecting wire according to claim 6, wherein the second front sections are gathered and joined to form a second front end portion, and the second rear sections are gathered and joined to form a second rear end portion.

8. The twisted connecting wire according to claim 7, further comprising: a second front terminal and a second rear terminal, the second front terminal is fixedly connected to the second front end portion, and the second rear terminal is fixedly connected to the second rear end portion.

9. The twisted connecting wire according to claim 1, further comprising: a bundle sleeve, wherein the bundle sleeve is set on an outer surface of the first twisted sections and the second twisted sections twisted together.
